(19) United States
(12) Patent Application Publication
(10) Pub. No.: US 2013/0260609 A1
(43) Pub. Date: Oct. 3, 2013

(54) Connector Assembly

(71) Applicant: TATUNG TECHNOLOGY INC, Taipei (TW)

(72) Inventor: Rui Shen LU, Taipei (TW)

(73) Assignee: Tatung Technology Inc, Taipei (TW)

(21) Appl. No.: 13/849,589

(22) Filed: Mar. 25, 2013

(30) Foreign Application Priority Data
Mar. 30, 2012 (CN) 201220126295.3

(51) Int. Cl. H01R 13/46

(52) U.S. Cl. CPC H01R 13/46
USPC 439/625

(57) ABSTRACT

A connector assembly includes a female-base and a male-base. The female-base includes a first metal element and a first sleeve element. When in use, the female-base and the male-base are engaged with each other such that the second sleeve element is disposed in interior of the first sleeve element, and that the first metal element contacts the second metal element, so that an electric connection is established for conveyance of power, and of video or audio signal. Thereby, users may use the connector assembly to eliminate the use of extension cords or signal cables, so that risks and worries about connecting too many extension cords may be released. In addition, a great number of electric cords and signal cables behind electronic appliances can be reduced, and arrangement of cords is simplified, let alone a neat and tidy overall appearance of the electronic appliances can be obtained.

### BACKGROUND OF THE INVENTION

1. Field of the Invention

The present invention relates to a connector assembly, and more particularly, to an assembly adapted for connecting power source or signals of electronic products.

2. Description of Related Art

Generally speaking, every electronic product should have at least one power-source connector. When a user attempts to use each individual electronic product, connecting an external power source sometimes is a must in order to use the same, namely, to plug in a power plug to a power connector of the electronic product and to connect the other end of the power plug to a common power source. By doing so, the electronic product is supplied with power and performs its function.

However, as the number of electronic products increases for every household, suppose each individual electronic product needs to connect the power source, then a great number of power outlets are required. Consequently, most households often purchase multi-socket extension cords for expansion of power outlets so as to satisfy the need. Nevertheless, in case the extension cords are used as a “multi-layer” connection, or a variety of electronic appliances are plugged in an extension cord, then the extension cords may be overloaded and a short circuit may occur.

Further, audio-video facilities are attached with signal cables for video and audio transmission, and in case several sets of the facilities are in use, there will be a huge number of cables, causing difficulties for cable arrangement.

Given the above, in an attempt to solve the problems, as mentioned above, research and experiments for a “Connector Assembly” has been undertaken, eventually resulting in accomplishment of the present invention.

### SUMMARY OF THE INVENTION

An object of the present invention is to provide a connector assembly, comprising a female-base and a male-base. The female-base includes a first metal element and a first sleeve element, wherein the first sleeve element is sleeved to the first metal element. The male-base includes a second metal element and a second sleeve element, wherein the second sleeve element is sleeved to the second metal element.

When in use, the female-base and the male-base are engaged with each other such that the second sleeve element is disposed in interior of the first sleeve element, and that the first metal element contacts the second metal element, so that an electric connection is established for power conveyance.

According to the present invention, the first metal element of the female-base is provided with a concave, wherein an annular wall is provided on the concave and a metal pillar protrusively provided from the concave. The first metal element, the annular wall, and the metal pillar are made integrally. The second metal element of the male-base is, at its center, provided with a metal circular pillar having a recess. The second metal element and the metal circular pillar are made integrally. When the female-base and the male-base are engaged with each other, the metal pillar of the female-base will be in contact with the metal circular pillar of the male-base so as to establish an electric connection for power conveyance.

Further, according to the present invention, the first metal element and the second metal element may relate to a socket and plug of a conventional 8-pin DIN connector for conveyance of video and audio.

The first metal element and the first sleeve element, and the second metal element and the second sleeve element, are interposed with an adhesive layer, respectively, so as to adhere together thereof; whereas other known adhering measure may also be applied.

Still further, according to the present invention, the first metal element of the female-base is provided with at least one through hole such that at least one fastener passes therethrough; whereas the second metal element of the male-base provided with at least one through hole such that at least one fastener passes therethrough, so that the female-base and the male-base are threadedly fastened onto corresponding locations of various electronic appliances. Consequently, by means of engagement of the female-base and the male-base, an electric connection can be established, so that electric power, and video or audio signals, can be transmitted between two electronic appliances.

Further, according to the present invention, to achieve the purpose of threadedly fastening together the female-base and the electronic appliance, a threaded portion may be provided at rear end of the female-base, so that whenever the female-base is attached to the electronic appliance, a nut can be used to achieve the purpose. Likewise, the male-base may be provided with such a fastening structure, so that attachment or detachment work may become easily.

Thereby, users may use the connector assembly, according to the present invention, to eliminate the use of extension cords, so that risks and worries about using too many extension cords may be released. In addition, a great number of electric cords and signal cables behind electronic appliances can be reduced, and arrangement of cords is simplified, let alone a neat and tidy overall appearance of the electronic appliances can be obtained.

Other objects, advantages, and novel features of the present invention will become more apparent from the following detailed descriptions when taken in conjunction with the accompanying drawings.

### BRIEF DESCRIPTION OF THE DRAWINGS

FIG. 1 is an exploded view illustrating a connector assembly according to a first embodiment of the present invention;

FIG. 2 is an exploded view illustrating a female-base of the connector assembly according to the first embodiment of the present invention;

FIG. 3 is an exploded view illustrating a male-base of the connector assembly according to the first embodiment of the present invention;

FIG. 4 is a cross-sectional view illustrating engagement of the male-base and the female-base according to the first embodiment of the present invention;

FIG. 5 is a front view illustrating attachment of the connector assembly, according to the first embodiment of the present invention, to an electronic appliance;

FIG. 6 is an exploded view illustrating the electronic appliance attached with the connector assembly according to the first embodiment of the present invention;

FIG. 7 is an exploded view illustrating a female-base according to a second embodiment of the present invention;

FIG. 8 is an exploded view illustrating a female-base according to a third embodiment of the present invention; and

FIG. 9 is an exploded view illustrating a male-base according to the third embodiment of the present invention.

### DETAILED DESCRIPTION OF THE PREFERRED EMBODIMENTS

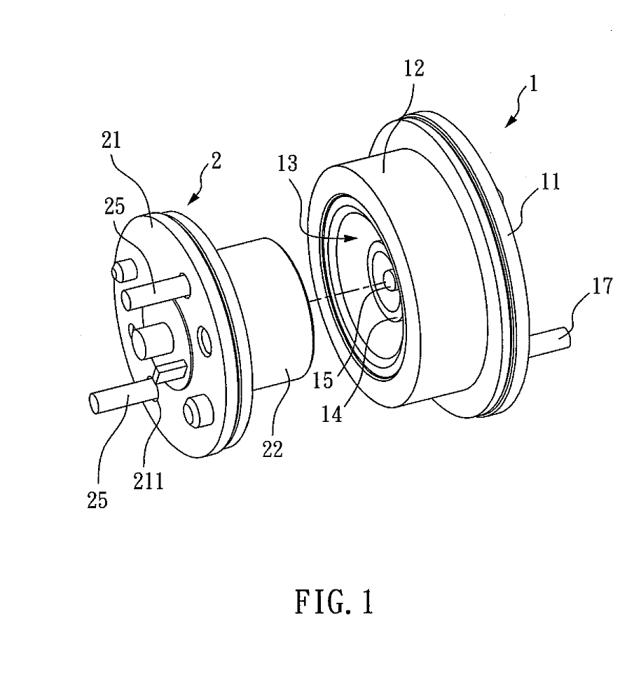

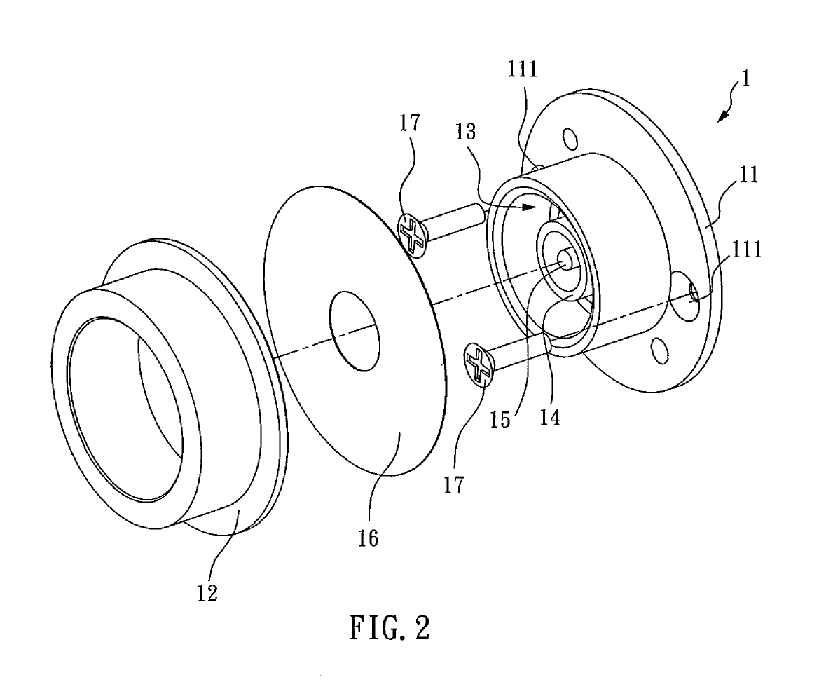

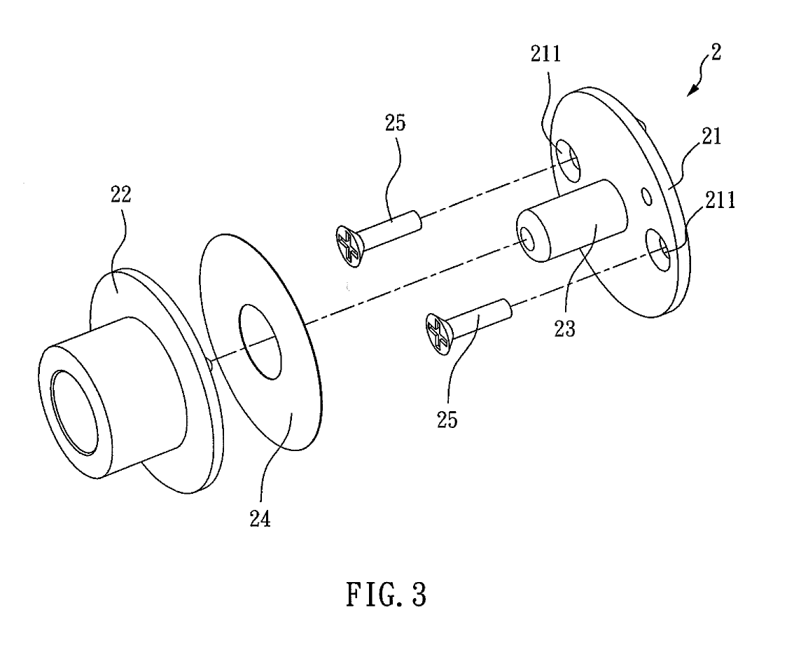

Referring to FIG. 1, an exploded view illustrating a connector assembly according to a first embodiment of the present invention; to FIG. 2, an exploded view illustrating a female-base of the connector assembly; and to FIG. 3, an exploded view illustrating a male-base of the connector assembly, the connector assembly, comprises a female-base 1 and a male-base 2, as shown in FIG. 1. Further, as shown in FIG. 2, the female-base 1 includes a first metal element 11 and a first sleeve element 12, wherein the first sleeve element 12 is sleeved to the first metal element 11 such that an adhesive layer 16 is applied to adhere together the first metal element 11 and the first sleeve element 12. The first metal element 11 is provided with a concave 13, wherein an annular wall 14 is provided on the concave 13 and a metal pillar 15 protrusively provided from the concave 13. In the first embodiment, the first metal element 11, the annular wall 14, and the metal pillar 15 are made integrally; or, alternatively, are made separately and then combined together. Further, the first metal element 11 is provided with two through holes 111, where two fasteners 17 are applied to secure the female-base 1 onto an electronic appliance.

As shown in FIG. 3, the male-base 2 includes a second metal element 21 and a second sleeve element 22, wherein the second sleeve element 22 is sleeved to the second metal element 21 such that an adhesive layer 24 is applied to adhere together the second metal element 21 and the second sleeve element 22. The second metal element 21 is, at its center, provided with a metal circular pillar 23 having a recess. In the present embodiment, the second metal element 21 and the metal circular pillar 23 are made integrally; or, alternatively, are made separately and then combined together. Further, the second metal element 21 is provided with two through holes 211, where two fasteners 25 are applied to secure the male-base 2 onto the electronic appliance.

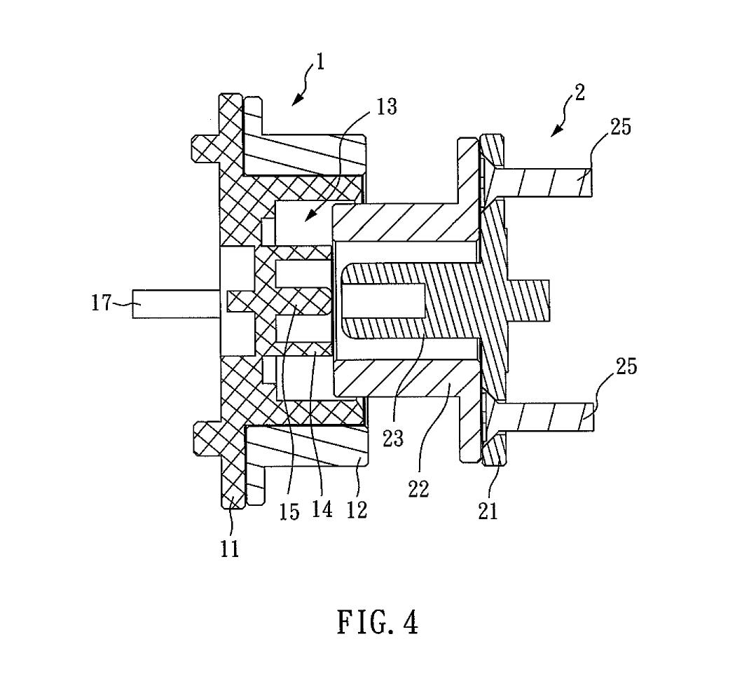

Now referring to FIG. 4, a cross-sectional view illustrating engagement of the female-base 1 and the male-base 2 according to the first embodiment of the present invention, when the female-base 1 and the male-base 2 are engaged with each other, the second sleeve element 22 will be disposed correspondingly in the first metal element 11, while the metal pillar 15 of the first metal element 11 will be inserted into the recess of the metal circular pillar 23 of the second metal element 21 such that the female-base 1 and the male-base 2 can be electrically connected with each other for power conveyance.

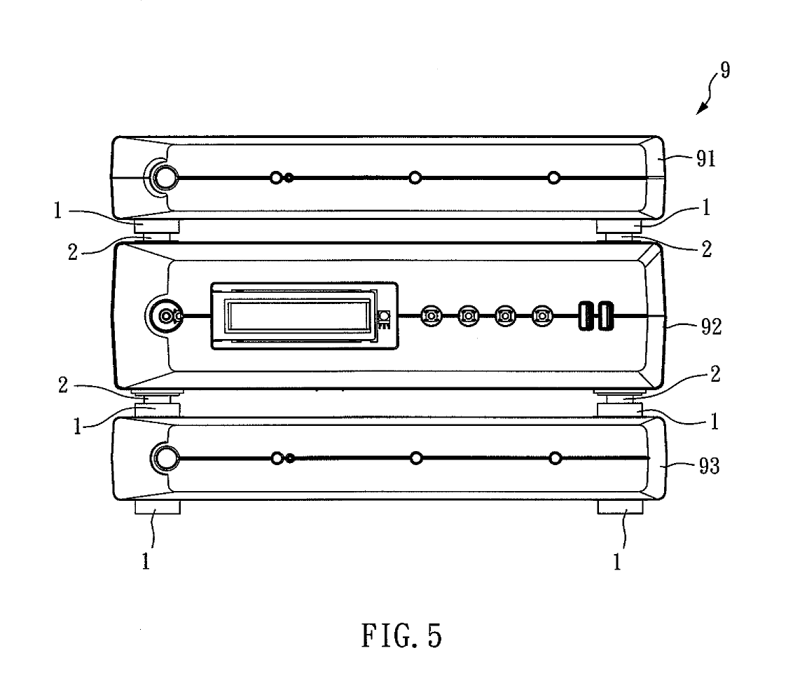

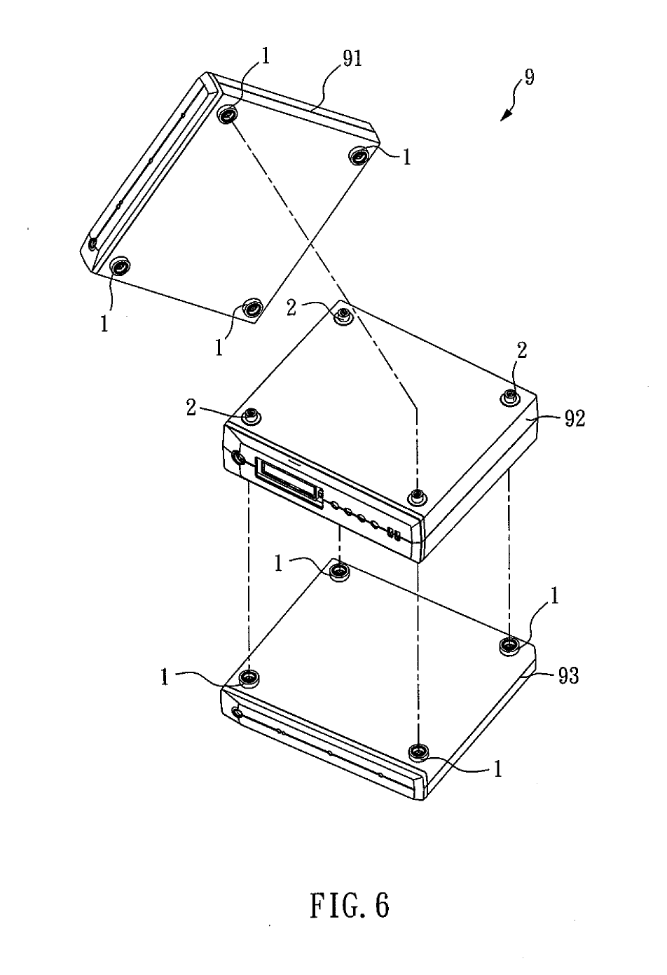

Further references are made to FIG. 5, a front view illustrating attachment of the connector assembly, according to the first embodiment of the present invention, to the electronic appliance; and to FIG. 6, an exploded view illustrating the electronic appliance attached with the connector assembly. An audio-video facility 9 is often stacked up with modules of various functions, including such as in the present embodiment, a status display module 91, a control module 92, an output module 93. For users' convenience in selection of desired modules, each individual module needs to be equipped with a power supply. However, in case plural modules are in use, a plurality of power sockets would be required, making arrangement of electric cords at backsides of the modules uneasy and unsightly.

By arranging the female-base 1 and the male-base 2, as shown in FIG. 5, between the status display module 91 and the control module 92, and between the control module 92 and the output module 93, a power source can be arranged at any of the status display module 91, the control module 92, and the output module 93. Then, through engagement of the female-base 1 and the male-base 2, power can be conveyed to other modules. Such will supply required power, without having each module connected with a power source cord and plugged in a power socket.

As shown in FIG. 6, to ensure connection with a power source for a sufficient power supply, and stabilization between two modules, four corners of each module may all be provided with corresponding female-bases 1 and male-bases 2. For example, the status display module 91 may, at its four corners, be provided with female-bases 1; while the control module 92, at its top corresponding to the female-base 1, is provided with male-bases 2. As such, when the status display module 91 is disposed on the control module 92, the female-bases 1 may be engaged with the male-bases 2 correspondingly, and be electrically connected with one another. A power conveyance can therefore be established between the status display module 91 and the control module 92, and so forth.

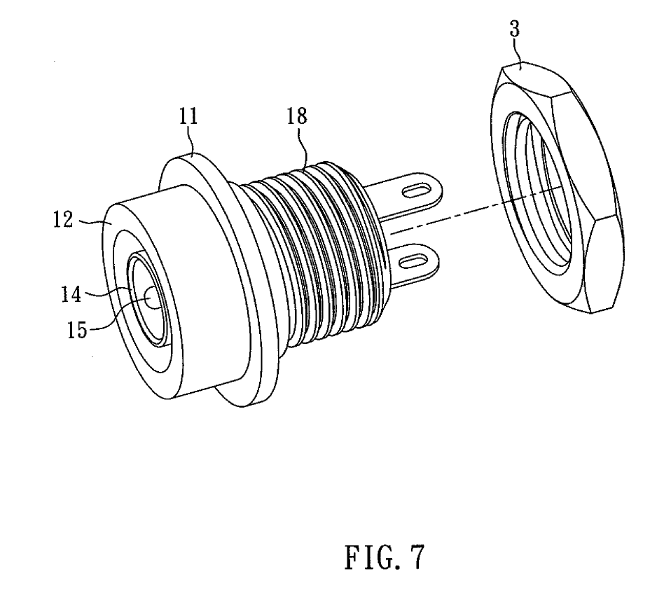

Reference may be made to FIG. 7, an exploded view illustrating a female-base according to a second embodiment of the present invention. The second embodiment is different from the first embodiment in that in the second embodiment, a threaded portion 18 is protruded from the rear of the first metal element 11. In case the female-base 1 is mounted to each module, a nut 3 can be used for securing the female-base 1 onto the module. Likewise, the male-base 2 may have a similar fastening structure so as to facilitate attachment and detachment of components.

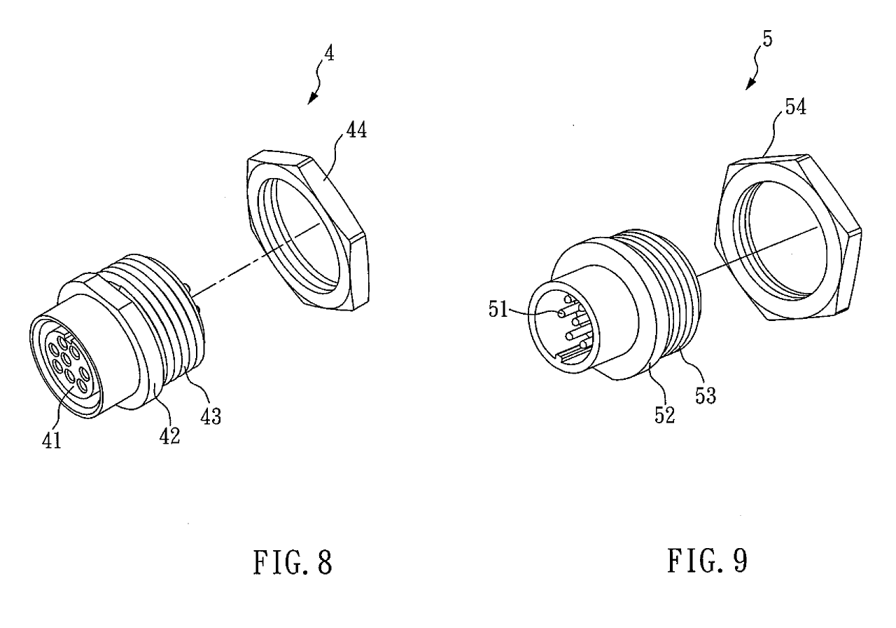

Now referring to FIG. 8, an exploded view illustrating a female-base according to a third embodiment of the present invention; and to FIG. 9, an exploded view illustrating a male-base according to the third embodiment of the present invention, a female-base 4 includes a first metal element 41, a first sleeve element 42, and a threaded portion 43; whereas a male-base 5 includes a second metal element 51, a second sleeve element 52, and a threaded portion 53. The second metal element 51 relates to an 8-pin DIN plug, while the first metal element 41 relates to a socket corresponding to the 8-pin DIN plug. When the female-base 4 is engaged with the male-base 5, the second sleeve element 52 will be disposed at interior of the first sleeve element 42; and the first metal element 41 be engaged with the second metal element 51 such that the female-base 4 and the male-base 5 are electrically connected with each other for transmission of video or audio signals. In addition, the female-base 4 and the male-base 5 are also provided, at rear, threaded portions 43, 53, as the second embodiment, for being engaged with nuts 44, 54, so as to secure the female-base 4 and the male-base 5 to the modules, respectively.

Although the present invention has been explained in relation to its preferred embodiments, it is to be understood that many other possible modifications and variations can be made without departing from the scope of the invention as hereinafter claimed.

What is claimed is:

1. A connector assembly, comprising:
a female-base, including a first metal element and a first sleeve element, wherein the first sleeve element is sleeved to the first metal element; and
a male-base, including a second metal element and a second sleeve element, wherein the second sleeve element is sleeved to the second metal element;
wherein, the female-base and the male-base are engaged with each other such that the second sleeve element is disposed in interior of the first sleeve element, and the first metal element contacts the second metal element.

2. The connector assembly as claimed in claim 1, wherein the first metal element of the female-base is provided with a concave, wherein an annular wall is provided on the concave and a metal pillar protrusively provided from the concave.

3. The connector assembly as claimed in claim 2, wherein the first metal element, the annular wall, and the metal pillar are made integrally.

4. The connector assembly as claimed in claim 1, wherein the first metal element and the first sleeve element are interposed with an adhesive layer so as to adhere together thereof.

5. The connector assembly as claimed in claim 1, wherein the second metal element of the male-base is, at its center, provided with a metal circular pillar having a recess.

6. The connector assembly as claimed in claim 5, wherein the second metal element and the metal circular pillar are made integrally.

7. The connector assembly as claimed in claim 1, wherein the second metal element and the second sleeve element are interposed with an adhesive layer so as to adhere together thereof.

8. The connector assembly as claimed in claim 1, wherein the first metal element of the female-base is provided with at least one through hole such that at least one fastener passes therethrough.

9. The connector assembly as claimed in claim 1, wherein the second metal element of the male-base is provided with at least one through hole such that at least one fastener passes therethrough.
